(19) United States
(12) Patent Application Publication
(10) Pub. No.: US 2005/0146424 A1
(43) Pub. Date: Jul. 7, 2005

(54) System for transmitting a signal indicating the functioning condition of a tire

(76) Inventor: Barbanti Giovanni, Casalecchio di Reno (IT)

Correspondence Address: BRADLEY ARANT ROSE & WHITE LLP, 200 CLINTON AVE. WEST, SUITE 900, HUNTSVILLE, AL, 35801, US

(21) Appl. No.: 10/735,473

(22) Filed: Dec. 12, 2003

(51) Int. Cl. B60C 23/00

(52) U.S. Cl. 340/445; 73/146; 116/34 B

(57) ABSTRACT

A system for transmitting a signal indicating the functioning condition of a tire comprises a generator of electricity (B1) connected to a code generator (B3) and an oscillator (B4) capable of generating a right frequency for transmitting the coded signal; a switch (B2) enables the circuit to transmit the signal when the switch commutes; the signal is then filtered by the filter (B5), emitted through the antenna (B6) picked up by a receiver (B7) aboard the vehicle.

### BACKGROUND OF THE INVENTION

The present invention relates to a system capable of transmitting a signal representing the functioning condition of a tire to a receiver founding aboard a vehicle. In particular, the invention discloses a system capable of transmitting a signal representing the exceeding, by the difference between the internal pressure of the tire and the atmospheric pressure, a pre-established threshold value. Therefore, this signal represents also the radial deformation of the tire. In fact, the radial deformation of the tire, for a given load, is proportional to the difference in pressure.

### PRIOR ART

Systems for surveying and signalling the internal pressure of a tire are known from the current technique. Eventually, the systems are also used for sensing and signalling a temperature between the temperature of the gas inside the tire and the temperature of other members of the group of the wheel, to which the temperature sensor is near or connected. In general, the reference pressure of the pressure sensor has a fixed value.

These sensors, in general electronically-controlled, are located or outside or, more often, inside the tire, and are connected to apparatuses processing the data and transmitting them to an external receiver.

The systems usually comprise an apparatus supplied to each tire to measure the pressure, eventually considering also the temperature inside the tire. The apparatus is also used for processing the data sensed by the sensors and for transmitting the data to an external receiver. This receiver is connected to a processing central unit that in its turn transmits a signal to the display device usually located on the vehicle cluster. The transmission of the signal from the apparatus of each tire to the external receiver occurs by means at least one transmitting and one receiving antenna. These systems also comprise at least one harness.

The functioning of said systems requires a considerable quantity of energy. The apparatus measuring the pressure and the temperature of each tire is, therefore, feed or with batteries or alternators or dynamo.

The typical problems of these systems are mainly as follows:
1. The systems do not function if they are not feed;
2. The systems continuously consume energy for functioning;
3. To save energy, the systems are acted during limited periods only. Therefore the transmission of the signal undergoes delays with respect to the occurring of the event to be sensed;

4. The information given by said systems needs a following processing by means of suitable devices to be at disposal of the addresses;

5. In general, the signals of the sensors are analogue, that is they are represented by the variation of quantities different from the ones to be sensed; therefore they need a conversion and a digitisation;

6. The signals successively need to be processed for interpreting their meaning;

7. All said operations on signals causes a decreasing in the precision, reliability and reproducibility;

8. The complexity of the systems is high, with a high number of components, with consequent cost-push, excessive dimensions and masses;

9. The physic feature of the data sensed does not allow to have information about the state of radial deformation of the tire, which is the most important parameter to value the functioning state of a tire.

### AIMS AND FEATURES OF THE INVENTION

The purpose of the invention is to remove these disadvantages. The invention, as claimed, solves the problem of creating a system for transmitting a signal indicating the functioning condition of a tire.

By using the invention the result of transmitting to the driver of a vehicle a warning signal is obtained, when the state of radial deformation of the tire exceeds a pre-established threshold.

This result is due to the co-operation of the present invention with a device as that disclosed in EP 0 893 284 and other pending patent documents.

The advantages offered by the invention are mainly as follows:
1. The function of the system is only to transmit a signal when the state of radial deformation of the tire exceeds a pre-established threshold;
2. The system is activated from outside by a switch to emit the signal;
3. The signal to be transmitted is on/off, therefore it is easy to obtain, process, transmit and interpret according any kind of codex or protocol;
4. The feature of point 3 allows the use of a central unit aboard the vehicle as receiver of the signal, for example the unit tele-controlling the opening of the doors;
5. The locating of the wheel sending the signal by the receiver through a simple processing that does need previously and strictly associate a specific apparatus to the wheel equipped with said apparatus;
6. Because of the function of point 5, it is possible to maintain the full functioning of the system, also after inversions of the position of replacing of the single wheels of the vehicle.

The system according to the present invention co-operates with a device signalling the inflating condition of the tire, wherein a movable group is found in a first loading position when the tire pressure is higher than the pre-established value,
the movable group is found, on the contrary, in a second unloading position when the tire pressure is lower than a pre-established value and, therefore, the tire is not suitable for a standard use,
the movable group consisting of, at least, a sensor, an amplifier, a transducer and an actuator,
the system is characterised by the fact that it is fitted with a switch commuting from a first to a second condition which is opposite to the first one when the movable group passes from the first loading position to the second unloading position to activate an apparatus sending a warning signal picked up by a receiver.

Advantageously, the receiver is located aboard the vehicle.

The signalling device is fitted with a first member for feeding energy for sending a warning signal.

The signalling device further comprises a second member for feeding energy for carrying out the processing functions inside the device.

The apparatus sends a signal indicating the charge condition of the electric generators.

A first processing function of the apparatus consists in the transmission, at pre-established time periods, of signals indicating the own proper functioning condition.

In order to save energy, the transmission of the signal of the proper functioning condition of the apparatus, at pre-established time periods, is not enabled when the group commutes the switch.

In order to identify the tire in failure and to limit the probability to receive signals from the devices out of the own vehicle, every single apparatus uses an own identifying code.

The apparatus comprises a receiver, which carries out a self-learning function to associate every single apparatus to the tire on which the apparatus is mounted. For this purpose the receiver associates the codes received according to the pre-fixed sequence to the pre-established position of any single wheel and it identifies the loading sequence.

The signal of right functioning, sent during the first loading, is used by the receiver for self-learning the position of every single tire relating every single installed apparatus. It is, in fact, sufficient to follow a pre-established loading sequence of the mounted devices, the total number of which is equal to the number of wheels of the vehicle, eventually including the spare wheels.

In order to associate every single apparatus to every single tire, a pre-established activation sequence is used; the first received code is associated to a first wheel, the second code to a second wheel, etc until the wheel n, being n the total number of wheels to be controlled.

In order to save energy, a movement sensor of the wheel is further provided in the apparatus, said sensor co-operating to prevent the transmission of the signal of the right functioning of the apparatus sent at pre-established time periods when the vehicle is stationary.

The apparatus is fitted with an autonomous generator of electricity formed by a winding linked to a magnetic field.

The apparatus is fitted with an autonomous generator of electricity formed by a winding linked to a magnetic field consisting of a magnet fixed on the structure of the vehicle near the wheel.

The apparatus is fitted with a receiving circuit in order to obtain a bi-directional transmitting system capable of limiting the feeding of energy just when the vehicle is running.

### BRIEF DESCRIPTION OF THE DRAWINGS

Other advantages, features and aims of the invention, may be more readily understood by referring to the accompanying drawings, which concern a preferred embodiment, in which:

FIG. 1 represents an longitudinal section of a device for sensing and signalling the state of radial deformation of a loaded tire co-operating with a system according to the present invention;

FIG. 2 represents the device of FIG. 1 wherein a switch is in contact with a plate, when the device is unloaded or during the loading phase.

FIG. 3 is a block figure showing the functioning of a system of transmission of the signal according to the invention.

### DESCRIPTION OF A PREFERRED EMBODIMENT OF THE INVENTION

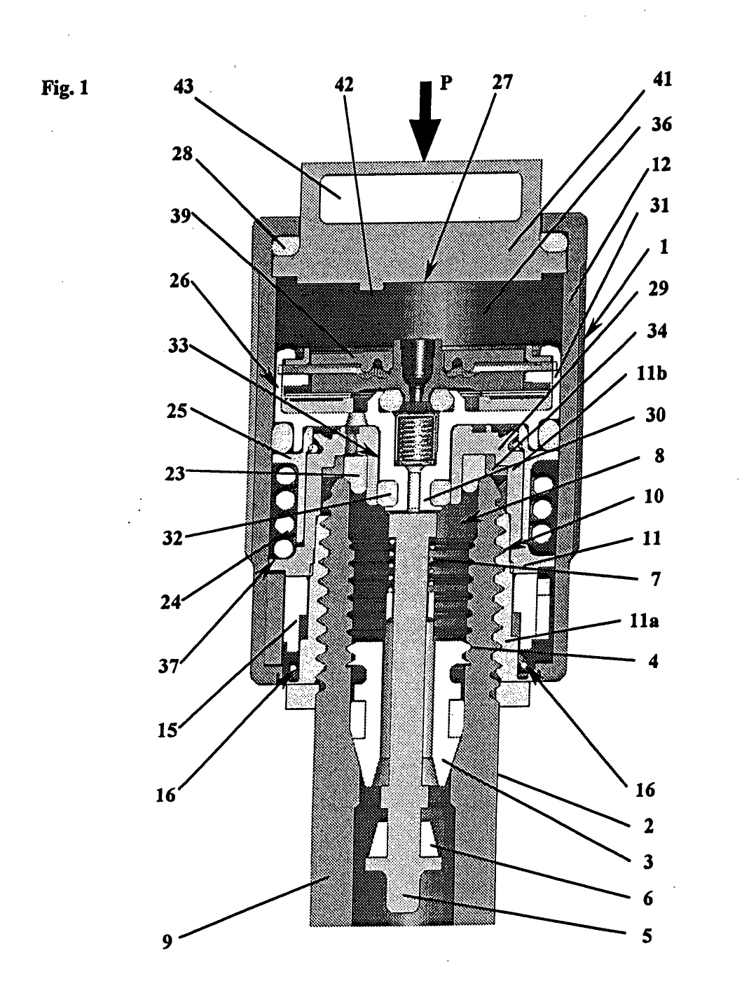

FIG. 1 represents a device 1 for sensing and signalling the state of radial deformation of a loaded tire, mounted on an usual tire inflating valve. Said valve substantially consists of a metal tube 2 housing a body 3 fixed, in its turn, inside through a threaded sealing connection 4. A self-closing member 5 axially slides inside the threaded connection 4. A sealing gasket 6 is held in the closing position by a spring 7. The self-closing member 5 is capable of automatically opening, when the pressure, in its part faced towards the outside, that is in the chamber 8, multiplied by the effective surface of the sealing gasket 6 generates on the self-closing member 5 a downwards axial force, is higher than the one due to the pressure existing in its part faced outside, that is in the chamber 9, or inside the tire, multiplied by the effective surface of the sealing gasket 6 added by the force of the spring 7. Vice-versa, for maintaining closed if the force due to the pressure in the part faced towards the outside (chamber 8) is lower than the one due to the pressure existing in the tire (chamber 9) by the force of the spring 7. Obviously, the self-closing member 5 is also open by a mechanical action from outside, by applying a force at its end, in inward direction as shown in FIG. 1.

The device 1 is screwed on the valve replacing the usual protecting cap. The device I and a good part of its internal member have an axial symmetric shape. The device 1 comprises a threaded body 11 consisting of two parts 11a and 11b welded each other; the threaded body 11 engages the threaded end 10 of the tire-inflating valve. An external envelope 12 is connected to the threaded body 11.

A sealing gasket 23 seals the chamber 8 and prevents undesired gas leaks when the device 1 is loaded.

The loading phase of the device 1 consists in applying an axial push P on the envelope 12 of FIG. 1, having module higher than the upwards push due to a spring 24. The spring 24 is located between the threaded body 11 and a centring sleeve 25, by means of which the spring 24 pushes upwards the group sensor/amplifier/transducer/actuator 26. Said group is unloaded during a time foregoing the screwing and clamping manoeuvre of the device 1 on the valve. Therefore the group rests on the wall 27 of a box 41 housing the system according to the present invention, wherein the box 41 is found at the opposite end of the threaded body 11 and is sealing stiffly connected to the envelope 12. The sealing is due to a gasket 28 located between the end of the envelope 12 and an abutting founding on the box 41.

A switch 42 extends from the wall 27 towards the chamber 36 for contacting a plate 39, which is a part of the group 26, when said group 26 is unloaded or during the loading phase. Therefore, in these conditions the switch 42 is in the state opposite to the one that it has when the device is loaded.

When the axial push P on the envelope 12 has a module higher than the upwards push due to the spring 24, the envelope 12 slides towards the valve 2. Contemporaneously the envelope 12 causes a push transmitting from the wall 27 to the group sensor/amplifier/transducer/actuator 26, which, in its turn, compresses the spring 24.

The push of the wall 27 on the group 26 causes the translation of the group 26 towards the upper wall 29 of the threaded body 11 until the abutting. During the descent, the lower end 30 of the housing 31 of the group 26 pushes the self-closing member 5 inwardly the valve 2 against the spring 7 and the push due to the pressure of the gas in the tire on the effective section of the gasket 6, and connects the chamber 9, joined to the inside of the tire, with the chamber 8, delimited by the end 10 of the valve 2, the upper wall 29 of the threaded body 11, the gasket 23 and by a gasket 32, which seals the lover end 30 of the housing 31 of the group 26 with the cylindrical hollow 33 founding in the upper wall 29 of the threaded body 11.

The gasket 6 is open until the group 26 is displaced towards the threaded body 11, that it is loaded, and automatically closes when the group 26 is far from the threaded body 11.

Apparatuses are housed inside the group 26 which are capable of carrying out the functions of measuring, amplifying and converting the signal coming from the difference between the pressure of the gas inside the tire and the atmospheric pressure, the apparatuses further indicating the exceeding the pre-established threshold. Said apparatuses are technically equivalent to those described in EP-A-0 893 284; for this reason, the features of those apparatuses may be more readily understood by referring to this document.

An annular gasket 35 separates the chamber 36; located between the wall 27 and the group, from the chamber 37, situated between the centring sleeve 25 and the external environment. The chamber 37 is connected to the external environment through a hole (not shown) at the basis of the threaded body 11. This gasket 35 co-operates with the spring 24 for obtaining the same function of the bellows of EP-A-0 893 284.

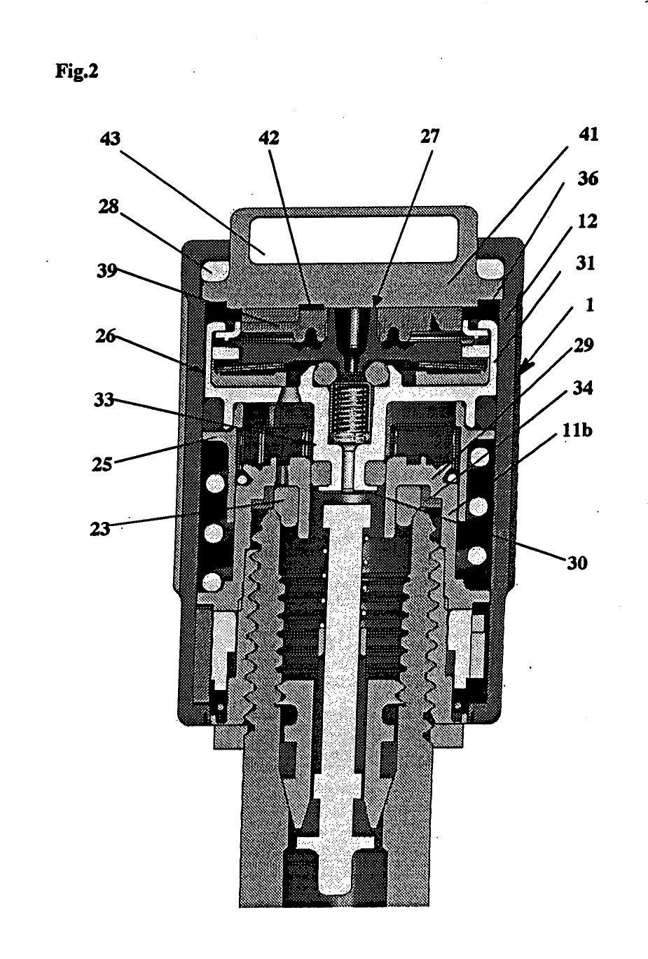

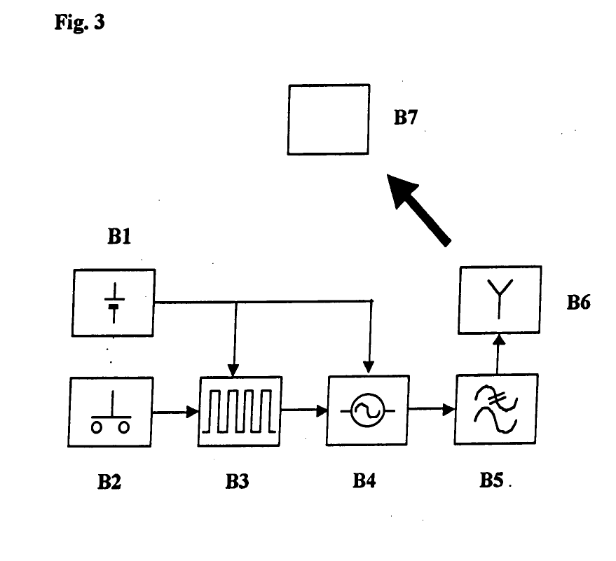

The circuit of FIG. 3 is provided inside the box 41. This circuit comprises a generator of electrical energy B1 (43 in FIGS. 1, 2), connected to a code generator with output PWM B3, and to an oscillator B4 capable of generating the right frequency for transmitting the coded signal. A switch B2 (42 in FIGS. 1, 2) enables the circuit to transmit the signal when the switch 42 changes over. The signal is successively filtered by the filter B5, emitted through the antenna B6 and picked up by a receiver B7 aboard the vehicle.

Since the signal generated by the group 26 of FIG. 1 is already defined in accordance to the event to be signalled, which is the exceeding of a pre-established threshold of the tire radial deformation, the emission of a simple railroad signal without any added information should be sufficient. But a so simple signal is insufficient to identifying the tire in failure, and in the case of proximity of more vehicles fitted with the device, it can be the cause of uncertainty. In fact an adjacent vehicle can receive the signal emitted by the device supplied to the tire of a vehicle. For identifying the tire in failure and decrease the probability of receiving signals from devices not related to own vehicle, a more complex code is necessary, which is typical of the single device. The code generator with output PWM (B3) generates this code.

Further functions obtained by means of codes generated by the code generator B3 consist of a code indicating the condition of electric charge of the generator of electrical energy and a code, transmittable with pre-established intervals of time, indicating the right condition of the circuit.

In order to the receiver B7 immediately identifies the tire in failure, it is necessary to follow a standard to associate the identifying code of the single device supplied to each tire to the position of the tire on the vehicle.

In the normal storage conditions, and however before the first assembly on the destination vehicle, the system is found in stand by conditions: the feeding is connected but no signal is sent.

Once the installation is carried out to the first armament, the commutation of switch 42, B2 actives the normal function in which the system is limited to emit the self-control signal of correct condition at the previewed cadence: such normal function will come then maintained for all the duration of loading state of the device.

The signal emitted at the moment of the first loading is used by the receiver B7 for self learning of the position of each single tire relative to each single sensor installed without the necessity of pre-memorising codes on the receiver. It is sufficient to follow a prefixed loading sequence of the mounted devices, the total number of which will be equal to the number of wheels of the vehicle, eventually comprised the spare wheels. The receiver associates the received codes according to the pre-established sequence to the prefixed position of the single wheels. For example, the first code received is associated to the left front wheel, the second to the front right wheel, etc until the wheel n, wherein n is the total number of wheels to be controlled. That avoids a prefixed correspondence between the code that the device is capable of transmitting and the single tire.

The choice of the described procedure does not require a fixed correspondence between the code of the device and the single tire. Therefore, it allows, both at the first mounting and in any moment of use of the vehicle, to change the disposition of the devices on the n wheels in any casual way and for any reason without losing the possibility of identification. For example, in case of puncture of the left front wheel, the driver takes care of replacing it with the spare wheel, even if it is not equipped with the device. It is sufficient to unscrew the device of the punctured wheel and mount it on the spare wheel (now mounted in place of the left front wheel) and re-load it: the receiver B7 recognises the emitted signal as associated to the left front. The same occurs for temporary assembly of snow tires, etc or replacement of the train tires.

In this way it is possible to eliminate all the particular formalities for starting or returning of use or for initialise or adjusting after any operation and/or unloading of one or more devices in any case.

In a not shown embodiment, the device is fitted with a receiving circuit, in order to obtain a bi-directional transmission system for limiting the energy consumption just when the vehicle is effectively used.

It is possible to act the functions of the devices just when the vehicle is used since an information about the using or stopping condition of the vehicle is transmitted to the devices supplied to each tire.

In a further not shown embodiment, the device is fitted with an inertial sensor capable of identifying the motion or rest condition of the vehicle. In this case, it is possible to act the functions of the devices only when the vehicle is moving.

In a further not shown embodiment, the device is fitted with a self-generator of electricity consisting of a winding linked to a magnetic field. The rotation of the device during the movement of the wheel induces an electromotive force in the winding, said force being used by the device or by a battery provided in the device. Known means are provided to allow a proper charge of the battery.

Advantageously, the linked magnetic field is generated by a magnet fixed on the structure of the vehicle near the wheel. Or, the magnetic field is terrestrial.

1. System for transmitting a signal indicating the functioning condition of a tire,
the system co-operates with a device signalling the inflating condition of the tire, wherein a movable group is found in a first loading position when the tire pressure is higher than the pre-established value,
the movable group is found, on the contrary, in a second unloading position when the tire pressure is lower than a pre-established value and, therefore, the tire is not suitable for a standard use,
the movable group consisting of, at least, a sensor, an amplifier, a transducer and an actuator,
the system is characterised by the fact that it is fitted with a switch commuting from a first to a second condition which is opposite to the first one when the group passes from the first loading position to the second unloading position to activate an apparatus sending a warning signal picked up by a receiver.

2. System for transmitting as in claims 1, wherein the receiver is located aboard the vehicle.

3. System for transmitting as in claims 1, wherein the signalling device is fitted with a first member for feeding energy for sending a warning signal.

4. System for transmitting as in claim 1, wherein the signalling device further comprises a second member for feeding energy for carrying out the processing functions inside the device.

5. System for transmitting as in claim 1, wherein the apparatus sends a signal indicating the charge condition of the electric generators.

6. System for transmitting as in claim 1, wherein a first processing function of the apparatus consists in the transmission, at pre-established time periods, of signals indicating the own proper functioning condition.

7. System for transmitting as in claim 1, wherein, in order to save energy, the transmission of the signal of the proper functioning condition of the apparatus, at pre-established time periods, is not enabled when the group commutes the switch.

8. System for transmitting as in claim 1, wherein, in order to identify the tire in failure and to limit the probability to receive signals from the devices out of the own vehicle, every single apparatus uses an own identifying code.

9. System for transmitting as in claim 1, wherein the apparatus comprises a receiver; the receiver carries out a self-learning function to associate every single apparatus to the tire on which the apparatus is mounted; for this purpose the receiver associates the codes received according to the pre-fixed sequence to the pre-established position of any single wheel and it identifies the loading sequence.

10. System for transmitting as in claim 1, wherein the signal of right functioning sent during the first loading is used by the receiver for the self-learning of the position of every single tire relating every single installed apparatus; it is, in fact, sufficient to follow a pre-established loading sequence of the mounted devices, the total number of which is equal to the number of wheels of the vehicle, eventually including the spare wheels.

11. System for transmitting as in claim 1, wherein to associate every single apparatus to every single tire, a pre-established activation sequence is used; the first received code is associated to a first wheel, the second code to a second wheel, etc until the wheel n, being n the total number of wheels to be controlled.

12. System for transmitting as in claim 1, wherein, in order to save energy, a movement sensor of the wheel is further provided in the apparatus, said sensor co-operating to prevent the transmission of the signal of the right functioning of the apparatus sent at pre-established time periods when the vehicle is stationary.

13. System for transmitting as in claim 1, wherein the apparatus is fitted with an autonomous generator of electricity formed by a winding linked to a magnetic field.

14. System for transmitting as in claim 1, wherein the apparatus is fitted with an autonomous generator of electricity formed by a winding linked to a magnetic field consisting of a magnet fixed on the structure of the vehicle near the wheel.

15. System for transmitting as in claim 1, wherein the apparatus is fitted with a receiving circuit in order to obtain a bi-directional transmitting system capable of limiting the feeding of energy just when the vehicle is running.
